(19) United States
(12) Patent Application Publication
(10) Pub. No.: US 2006/0016342 A1
(43) Pub. Date: Jan. 26, 2006

(54) Kettle having offset opening and recessed lid

(76) Inventors: James Wilson, Norwood, MA (US); Gregg Flender, Bedford, MA (US); John Costello, Wellesley, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/895,029

(22) Filed: Jul. 20, 2004

(51) Int. Cl. B67D 1/00

(52) U.S. Cl. 99/275

(57) ABSTRACT

A kettle for heating water or other liquid has an offset fill opening, e.g., to provide for easier filling of the kettle. A top portion of the kettle may include a relatively low thermal conductivity material to help reduce heat transfer through the top portion. A lid used to cover the fill opening may be recessed in the top portion of the kettle container so an upper end of the lid is flush with the top portion. The lid may have a gripping portion positioned below the upper surface of the top portion. The lid may have a bowl-shape with a gripping portion provided at an upper end of the bowl-shape.

### RELATED APPLICATIONS

This application is related to co-pending application Ser. No. ______, filed Jul. 20, 2004, entitled KETTLE HAVING MOVABLE SPOUT LID AND ACTUATOR, bearing Attorney Docket No. W0543.70081US00, and application Ser. No. ______, filed Jul. 20, 2004, entitled KETTLE HAVING SPOUT LINER AND SPOUT JACKET, bearing Attorney Docket No. W0543.70082US00. These applications are hereby incorporated by reference in their entirety.

### BACKGROUND OF INVENTION

1. Field of Invention

This invention relates to a kettle for heating liquid, such as water.

2. Description of Related Art

Tea kettles are widely used for heating a liquid, such as water, on a stovetop or other heat source. Some tea kettles have a built-in heat source, such as an electric resistance heating element, and need not be heated by an external heat source. Regardless of the heating mechanism, water or other liquid must be placed in the kettle for heating. In some kettles, water is introduced into the kettle through a spout that is also used to dispense the water from the kettle. Other kettles have an opening separate from the spout that is used for filling the kettle. Such openings are typically positioned at the top center of the kettle and are covered by a lid. Often, the opening and corresponding lid are located under a handle for holding the kettle.

### SUMMARY OF INVENTION

The inventors have discovered that in some cases filling of a kettle that has an opening positioned under the kettle handle can be problematic. For example, removal of the lid covering the opening can be made difficult because the handle is frequently in the way of easy lid removal. Moreover, filling of the kettle through the opening positioned under the kettle handle may require that the kettle be tipped to one side so that the handle is positioned out of the way of water entering the opening.

In one aspect of the invention, a kettle for heating a liquid includes a container having a substantially flat bottom portion and a top portion with an opening through which to receive liquid. A spout is connected to the container and constructed and arranged to allow liquid to be poured from the container. A handle is connected to the container and constructed and arranged to be gripped by a human hand and allow carrying of the container. The handle, when in use for carrying the kettle, generally extends along a handle axis above the top portion of the container. The opening has an area and is positioned in the top portion so that a majority of the area of the opening is offset to one side of a region directly below the handle when positioned for use.

In another aspect of the invention, a kettle for heating a liquid includes a container having a substantially flat bottom portion and a top portion with an opening through which to receive liquid. A spout is connected to the container and constructed and arranged to allow liquid to be poured from the container. A handle is connected to the container and constructed and arranged to be gripped by a human hand and allow carrying of the container. The handle, when in use for carrying the kettle, generally extends along a handle axis above the top portion of the container. The opening is positioned in the top portion and has a center that is offset from a vertical plane that includes the handle axis.

In another aspect of the invention, a kettle includes a container having a lower portion with a substantially flat bottom portion and a first thermal conductivity. The container also has a non-metallic top portion with an opening through which to receive the liquid. The top portion has a second thermal conductivity lower than the first conductivity and is permanently secured to the lower portion. A spout is connected to the container and constructed and arranged to allow liquid to be poured from the container. A handle is connected to the container and constructed and arranged to be gripped by a human hand and allow carrying of the container.

In another aspect of the invention, a kettle for heating a liquid includes a container having a substantially flat bottom portion and a top portion with an opening through which to receive liquid. A handle is connected to the container and constructed and arranged to be gripped by a human hand and allow carrying of the container while holding the amount of liquid. A spout is connected to the container and constructed and arranged to allow liquid to be poured from the container. A lid is constructed and arranged to cover the opening in the top portion of the container, and has an upper end and a bottom end. The bottom end is received into the container and the upper end is flush with the top portion of the container when the lid is in place to cover the opening. The lid has a gripping portion that is positioned below the upper end of the lid and is constructed and arranged to provide for removal of the lid from the opening by gripping the lid without the use of a thumb.

In another aspect of the invention, a kettle for heating a liquid includes a container having a substantially flat bottom portion and a top portion with an opening through which to receive liquid. A handle is connected to the container and constructed and arranged to be gripped by a human hand and allow carrying of the container while holding the amount of liquid. A spout is connected to the container and constructed and arranged to allow liquid to be poured from the container. A lid is constructed and arranged to cover the opening in the top portion of the container, and has a bowl shape arranged so that an inner side wall forming the bowl shape provides a surface by which the lid may be pulled using one or more fingers to remove the lid from the opening.

Various other aspects of the invention will be apparent and/or obvious from the following detailed description. It should be noted that when incorporated in a particular embodiment, various aspects of the invention may be combined and used together, or may be used separately from other aspects of the invention.

### BRIEF DESCRIPTION OF THE DRAWINGS

Various aspects of the invention are described below with reference to the following drawings, in which like numerals reference like elements, and wherein:

FIG. 1 is a perspective view of an illustrative embodiment incorporating various aspects of the invention;

FIG. 2 is a side view of the FIG. 1 embodiment;

FIG. 3 is a top view of the FIG. 1 embodiment;

FIG. 4 is a cross-sectional view along the line 4-4 shown in FIG. 3;

FIG. 5 is a front view of the FIG. 1 embodiment;

FIG. 6 is a rear view of the FIG. 1 embodiment; and

FIGS. 7 and 8 show top and perspective views, respectively, of a lid in one aspect of the invention.

### DETAILED DESCRIPTION

Aspects of the invention are described below with reference to illustrative embodiments. However, it should be understood that aspects of the invention are not limited to those embodiments described below, but instead may be used in any suitable arrangement. For example, a kettle having an approximately cylindrical shape and rounded top is shown in the drawings, but a kettle in accordance with various aspects of the invention may have any size, shape or other configuration.

In one aspect of the invention, a kettle has an opening through which a liquid may be provided into the kettle container that is offset from a center of the container top. Offset of the opening from the center of the top may allow for easier filling of the kettle. For example, offset of the opening may allow a user to comfortably hold the kettle by the handle without tipping or other manipulation and introduce a stream of water through the opening without wetting either the hand or handle. This is contrast to some kettles that have a fill opening locating at a center of the top under the handle. With such kettles, it is frequently the case that the user must tip the kettle to one side or otherwise maneuver the kettle so that water may be introduced into the opening without contacting the handle or the user's hand. In addition, an offset opening may allow a user to more intuitively understand how the kettle may be filled without tipping or other kettle manipulation.

In one aspect of the invention, the opening may be offset so that a majority of the area of the opening is located to one side of a region located directly under the handle. In another aspect of the invention, the opening may be located to one side of a vertical plane that includes an axis along which the handle extends.

In another aspect of the invention, the opening may be offset relative to the handle so that a vertical line passing through the center of the opening is offset from and does not pass through any portion of the handle. Such an arrangement may allow a vertical stream of water (water typically exits a faucet outlet to form a vertical stream) to safely pass a handle and user's hand grasping the handle to enter the kettle through the opening. As a result, the kettle may be filled while the user comfortably holds the kettle by the handle without need for tipping or otherwise adjusting the position of the kettle.

In another aspect of the invention, a top portion of the kettle container may be curved and have a radius. The opening may be located in the top portion so that a radius of the top portion passing through the center of the opening is transverse to the plane of a substantially flat bottom portion of the container as well as lie outside of a vertical plane that includes the handle axis.

In another aspect of the invention, a line that extends from a center of a substantially flat bottom portion of the kettle container to a center of an opening in the top of the container may be transverse to the plane of the bottom portion. In addition, this line may be transverse to a vertical plane that contains the handle axis.

In another aspect of the invention, a kettle may include a container having a metallic lower portion, e.g., made of stainless steel, copper or other suitable metal, and a plastic top portion secured to the lower portion. The plastic top portion may have a lower thermal conductivity than a material used to form the lower portion, and may reduce the risk of burning, such as by inadvertent contact of the container top portion by a user and/or may reduce the heat loss of the container through the top of the kettle.

In another aspect of the invention, a lid used to cover an opening in a top of the kettle container may be recessed so an upper end of the lid is flush with the top portion of the container. In another aspect of the invention, the lid may have a recessed portion that provides a gripping region or lip that may be grasped and pulled by a user to remove the lid from the opening. For example, in one embodiment, the lid may have a bowl-shape in which a lip at the top end of the lid may provide a gripping surface for manipulating the lid. Such an arrangement may provide for easier opening characteristics of the lid, such as for persons that have limited or no ability to grasp a handle between fingers and thumb. In this aspect of the invention, a lip of the lid may be grasped by fingers only and removed from the opening, requiring little of no strength from the user's thumb.

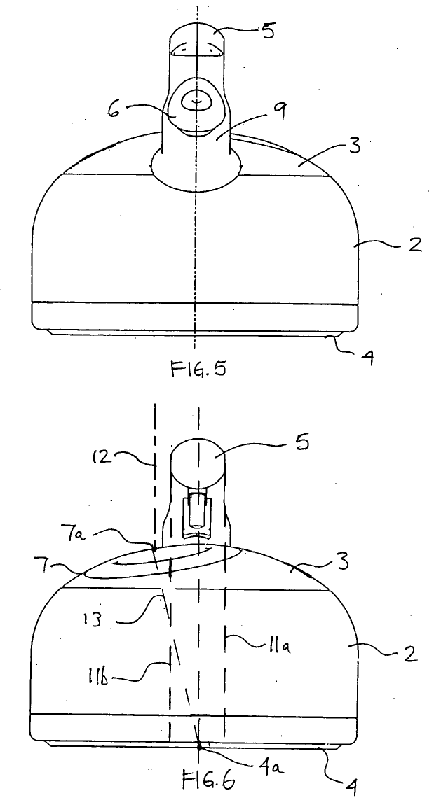

FIGS. 1-6 show an illustrative embodiment that incorporates several aspects of the invention. As can be seen in FIG. 1, this illustrative embodiment of a tea kettle 1 includes a container 2 that may be made of any suitable material, such as one that is highly thermally conductive and has a relatively high melting point, such as stainless steel, copper, aluminum or other metals. The container 2 may have any suitable size or shape and may be made from one unitary piece, or as an assembly of two or more pieces. In this illustrative embodiment, the container 2 has an approximately cylindrical shape with a rounded top portion 3 and a substantially flat bottom portion 4.

In accordance with one aspect of the invention, the top portion 3 may be made of a different material or combination of materials than a lower portion of the container 2, or even the substantially flat bottom portion 4. For example, the top portion 3 may be made of a suitable plastic or other material having a relatively low thermal conductivity. In contrast, the lower section of the container 2 may be made of a material having a higher thermal conductivity, such as a metal. For example, the lower portion of the container 2 may have bottom portion 4 made of a highly conductive material, such as copper or aluminum, and have another portion above the bottom portion that is made of a lower conductivity material, such as stainless steel. In such an arrangement, the thermal conductivity of the lower portion of the container 2 is considered to be an average of the conductivities of the various constituent parts. The higher thermal conductivity material in the lower portion of the container may aid in rapidly heating the water or other liquid in the container 2. In contrast, the lower thermal conductivity material at the top portion 3 may help to thermally insulate the liquid and help reduce heat loss through the top portion of the container 2. In addition, the lower thermal conductivity material at the top portion 3 may help reduce the risk that a user's hand is burned through inadvertent or intentional contact with the top portion 3. The top portion 3, such as one made of a nylon or other suitable plastic, may be permanently secured to the lower portion. For example, studs or plugs of plastic material may extend from the top portion 3 through corresponding holes in the lower portion of the container 2 and be thermally welded (e.g., by sonic means) to form a type of rivet that joins the top portion to the lower portion. Of course, in other aspects of the invention, it will be understood that the lower portion and the top portion of the container may be made of a single type of material, such as stainless steel, and may be made from a single unitary part.

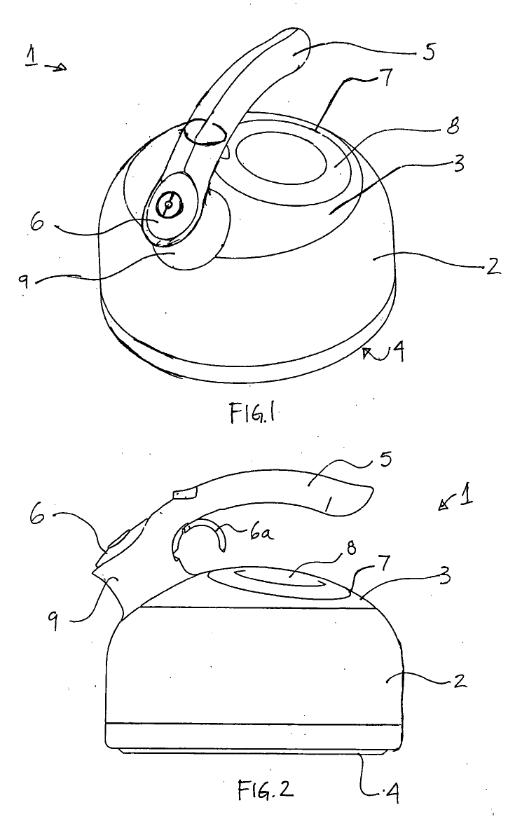

In another aspect of the invention, a spout 9 of the kettle 1 through which liquid may be poured from the container 2 may be integrally formed with the top portion 3. That is, the top portion and the spout 9 may be molded from a suitable plastic material to form a single piece, or may otherwise be attached together. Similarly, in another aspect of the invention, the handle 5 may be integrally formed with the spout 9 and/or with the top portion 3. It should be appreciated, however, that these aspects of the invention are not required, and the spout and/or handle may be made separate from the top portion 3 or each other and may be secured to the container 2 or otherwise formed in other ways. For example, the spout 9 may extend from a sidewall of the container 2 as is known in the art. Likewise, the handle 5 may be attached to other portions of the container 2 and may be separate from the spout 9. Also, the handle 5 need not be fixed in place, but instead may, for example, be pivotally mounted to the container 2 so that the handle 5 may fold down, e.g., for storage. The handle 5 may be folded up to extend over the top of the container for use in carrying the kettle. The kettle 1 may also include a cover 6 to cover the discharge area of the spout 9 and may optionally include a whistle or other element to indicate that the water or other liquid has been suitably heated. The cover 6 may be associated with a trigger 6a (see FIG. 2) or other suitable mechanism to allow a user to open and/or close the cover 6 as is known in the art. The trigger 6a or other control mechanism for the cover 6 may be arranged in any suitable way.

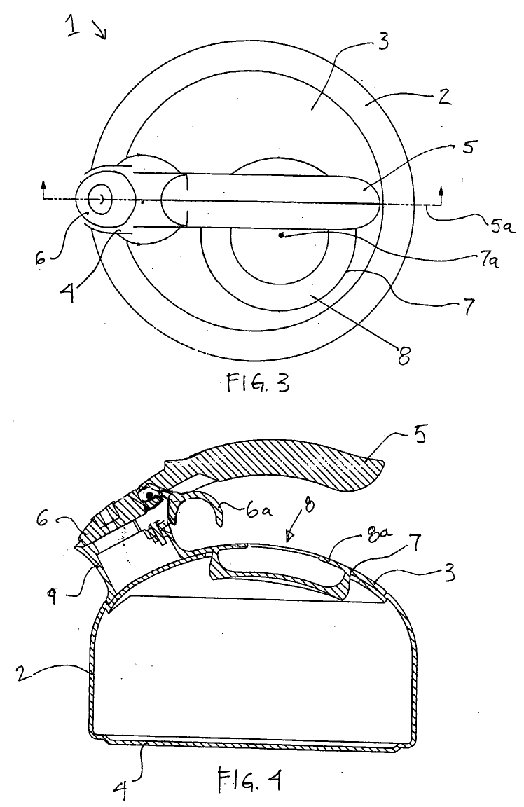

In another aspect of the invention, the container 2 may include an opening 7 that is offset to one side of the handle 5. The figures show the opening 7, which is formed in the top portion 3 covered by a lid 8. As can be seen in FIG. 3, the opening 7 is offset from the handle 5 to allow easier filling of the container 2.

In one aspect of the invention, the opening 7 is positioned so that a majority of the total area of the opening 7 is located on one side of a vertical plane that includes the handle axis. In the illustrative embodiment in FIG. 3, the handle 5 generally extends along a handle axis 5a above the top portion 3 of the container 2. As used herein, a handle axis 5a is a line that extends generally along a center of the handle 5 when the handle 5 is in use for carrying the kettle 1. Thus, although the handle 5 may be curved, split into two or more sections or have other irregular shapes, the handle axis 5a is a line that generally bisects the handle 5. As can be seen in FIG. 3, a vertical plane (i.e., a plane perpendicular to the drawing in FIG. 3) that includes the handle axis 5a has a majority of the area of the opening 7 located on one side (the bottom as shown in FIG. 3) of the plane.

In another aspect of the invention, a center of the opening in the top portion of the container is offset to one side of vertical plane that includes the handle axis. For example, as can be seen in FIG. 3, a center 7a of the opening 7 is positioned below the vertical plane that includes the handle axis 5a. As used herein, a center of the opening is a point that is analogous to a center of mass or a center of gravity of the shape of the opening. In this case, the opening 7 has a circular shape, and thus the center 7a is located at the center of the circle that defines the opening 7. However, the opening 7 may have other shapes, including irregular shapes. In the case of an irregular shaped opening 7, the center 7a is that point that would define a center of mass or a center of gravity for the shape of the opening.

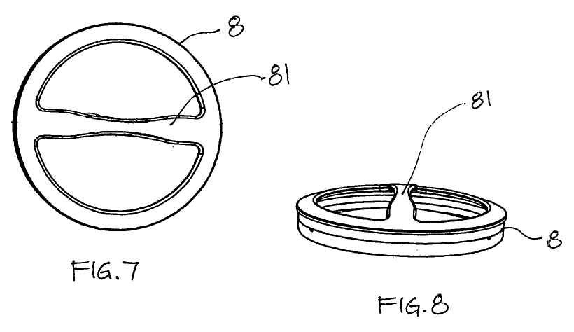

In another aspect of the invention, the opening in the top section of the container is offset so that a majority of the area of the opening is located to one side of a space directly beneath the handle when in a position used to carry the kettle. For example, as can be seen in FIG. 3, a majority of the area of the opening 7 is located toward a bottom side of the drawing in FIG. 3 relative to the space or region directly beneath the handle 5. FIG. 6 shows another view of this arrangement, in which the lines 11a and 11b are projected vertically downward from the handle 5 and define a space or region directly below the handle 5. It can be seen that the majority of the area of the opening 7 is positioned to the left as shown in FIG. 6 of the space or region directly beneath the handle 5. This offset of the opening 7 may allow for easier filling of the container 2 because a relatively large area is located in a space that is not directly beneath the handle 5. As a result, a user can hold the kettle 1 by the handle 5 and easily fill the container 2 through the offset opening 7.

In another aspect of the invention, the opening in the top portion of the container 2 is offset so that a vertical line passing through the center of the opening is offset from, and does not pass through any portion of, the handle 5. For example, as shown in FIG. 6, a vertical line 12 that passes through the center 7a of the opening 7 is offset to the left from the handle 5 and does not pass through any portion of the handle 5. Such an arrangement may be advantageous because a stream of water or other liquid that is used to fill the container 2 will frequently be oriented along a vertical line, e.g., water exiting a faucet will typically fall in a vertical direction. By offsetting the center of the opening so that a vertical line passing through the center does not pass through the handle 5, a vertical stream of water may pass through or near the center of the opening without contacting the handle and/or the user's hand when filling the kettle 1.

In another aspect of the invention, a line that extends from a center of the substantially flat bottom portion of the container to a center of the opening is transverse to the plane of the flat bottom portion and is transverse to a vertical plane that includes the handle axis. For example, as shown in FIG. 6, a line 13 that extends from a center 4a of the substantially flat bottom portion 4 to the center 7a of the opening 7 is transverse to the plane of the flat bottom portion 4 and is transverse to a plane that includes the handle axis 5a. To allow the container 2 to be properly balanced when the kettle 1 is held by the handle 5, the handle 5 will typically be positioned directly above a center of the bottom portion 4. An arrangement in which a line extending from the center 4a of the bottom portion 4 to the center 7a of the opening 7 is transverse to the plane of the bottom and to a vertical plane including the handle axis 5a allows for easier filling of the container 2 through the opening 7.

In another aspect of the invention, a lid that covers the opening in the top portion of the container may be received into the opening so that the upper end of the lid is flush with the top portion of the container. For example, as can be seen in the cross-sectional view in FIG. 4, an upper end of the lid 8 that is formed by a flange or lip 8a is flush with the top surface 3 so that the lip 8a matches the contour of the top portion 3. Although the lid 8 may have any suitable arrangement, in this illustrative embodiment, the lid has a bowl shape with a circular lip 8a extending around the periphery of the upper end of the bowl. It should be understood that the bowl-shape shown in the figures is only one such bowl-shape with a circular cross-section. Other bowl-shapes are possible, such as those having a rectangular, oval, irregular or other suitable cross-section. What is meant by a bowl-shape is that the lid has a recessed center portion with raised sides. Such an arrangement may allow for easier removal of the lid 8 because the lip 8a may allow a user to grasp and pull the lid 8 from the opening 7 without the need to grip a handle between fingers and thumb. Also, the recessed nature of the lid 8 may allow for easier operation of the trigger 6a.

In one aspect of the invention, the lid may have a gripping portion that is at least partially insulated from other portions of the lid to keep the gripping portion relatively cool and easier allow removal of the lid. For example, the lip 8a on the lid may have a double wall structure such that the gripping portion of the lip 8a is insulated by an air space or other insulator from other portions of the lid. Alternately, the lip 8a may have holes or other openings around its periphery, e.g., at the connection between the lip 8a and the sidewall of the lid 8, to reduce the heat transferred to the lip 8a.

In another aspect of the invention, a lid that covers the opening in a top portion of a container of a kettle may have a bottom, a sidewall extending upwardly from the bottom and a flange extending at an angle from an upper end of the sidewall. The lip may provide a grasping point for a user to grip and remove the lid from the opening without the need to grasp the lid between thumb and fingers. In one embodiment, the sidewall may extend upwardly from a periphery of the bottom and the lip may extend inwardly from an upper end of the sidewall.

It should be understood, however, that in embodiments incorporating aspects of the invention, the lid may have any suitable arrangement. For example, FIGS. 7 and 8 show an alternate lid arrangement in which the lid 8 has a crossbar 81 extending from one side of the lid 8 to the other. The crossbar 81 may provide a handle or gripping area that a user may grasp to remove the lid 8 from the opening 7. The crossbar 81 may also help insulate the gripping area from portions of the lid 8 to keep the gripping area relatively cool.

Having described particular embodiments of the invention in detail, various modifications and improvements will readily occur to those skilled in the art. Such modifications and improvements are intended to be part of this disclosure and within the spirit and scope of the invention. Accordingly, the foregoing description is by way of example only and the invention is defined by the following claims and their equivalents.

1. A kettle for heating a liquid, comprising:
a container arranged to hold an amount of liquid, the container having a substantially flat bottom portion and a top portion with an opening through which to receive the liquid;
a spout connected to the container and constructed and arranged to allow liquid to be poured from the container; and
a handle connected to the container and constructed and arranged to be gripped by a human hand and allow carrying of the container while holding the amount of liquid, the handle, when in use, generally extending along a handle axis above the top portion of the container;
wherein the opening has an area and is positioned in the top portion so that a majority of the area of the opening is offset to one side of a region directly below the handle.

2. The kettle of claim 1, wherein the majority of the area of the opening is located on one side of a vertical plane that includes the handle axis.

3. The kettle of claim 1, wherein the top portion includes a curved shape having a radius.

4. The kettle of claim 3, wherein the opening is positioned in the top portion so that a radius of the top portion that passes through a center of the opening is transverse to a plane of the substantially flat bottom portion of the container.

5. The kettle of claim 1, wherein the spout and the handle are integrally formed.

6. The kettle of claim 1, wherein the spout and the top portion are integrally formed.

7. The kettle of claim 1, wherein the container has a metallic lower portion, including the substantially flat bottom portion, and a plastic top portion, the plastic top portion being permanently secured to the metallic lower portion.

8. The kettle of claim 1, wherein the container has a lower portion, including the substantially flat bottom portion, that has a first thermal conductivity, and the top portion has a second thermal conductivity that is lower than the first thermal conductivity.

9. The kettle of claim 1, further comprising a lid that is constructed and arranged to cover the opening.

10. The kettle of claim 9, wherein the lid has a recess that forms a lip that provides a gripping surface to pull the lid from the opening.

11. The kettle of claim 9, wherein the lid has a bottom, a sidewall extending upwardly from at least a portion of a periphery of the bottom, and a lip extending inwardly from at least a portion of the sidewall.

12. The kettle of claim 9, wherein the lid has a bowl-shape with an inwardly extending lip at an upper end of the lid.

13. The kettle of claim 9, wherein the lid is constructed and arranged to be received into the opening so that an upper end of the lid lies flush with the top portion.

14. The kettle of claim 13, wherein the lid comprises a gripping portion that is positioned below the upper end of the lid.

15. A kettle for heating a liquid, comprising:
a container arranged to hold an amount of liquid, the container having a substantially flat bottom portion and a top portion with an opening through which to receive the liquid;
a spout connected to the container and constructed and arranged to allow liquid to be poured from the container; and
a handle connected to the container and constructed and arranged to be gripped by a human hand and allow carrying of the container while holding the amount of liquid, the handle, when in use, generally extending along a handle axis above the top portion of the container;
wherein the opening is positioned in the top portion and has a center that is offset from a vertical plane that includes the handle axis.

16. The kettle of claim 15, wherein the bottom portion of the container has a bottom center and the opening has an opening center; and
wherein a line extending from the bottom center to the opening center is transverse to a plane of the substantially flat bottom portion.

17. A kettle for heating a liquid, comprising:
a container arranged to hold an amount of liquid, the container having a lower portion with a substantially flat bottom portion, the lower portion having a first thermal conductivity, the container further having a non-metallic top portion with an opening through which to receive the liquid, the top portion having a second thermal conductivity lower than the first conductivity, the top portion being permanently secured to the lower portion;
a spout connected to the container and constructed and arranged to allow liquid to be poured from the container; and
a handle connected to the container and constructed and arranged to be gripped by a human hand and allow carrying of the container while holding the amount of liquid.

18. The kettle of claim 17, wherein the handle, when in use, generally extends along a handle axis above the top portion of the container, and the majority of an area of the opening is located on one side of a vertical plane that includes the handle axis.

19. The kettle of claim 17, wherein the top portion includes a curved shape having a radius.

20. The kettle of claim 19, wherein the opening is positioned in the top portion so that a radius of the top portion that passes through a center of the opening is transverse to a plane of the substantially flat bottom portion of the container.

21. The kettle of claim 17, wherein the spout and the handle are integrally formed.

22. The kettle of claim 17, wherein the spout and the top portion are integrally formed.

23. The kettle of claim 17, wherein the container has a metallic lower portion, including the substantially flat bottom portion, and a plastic top portion, the plastic top portion being permanently secured to the metallic lower portion.

24. The kettle of claim 17, further comprising a lid that is constructed and arranged to cover the opening.

25. The kettle of claim 24, wherein the lid has a recess that forms a lip that provides a gripping surface to pull the lid from the opening.

26. The kettle of claim 24, wherein the lid has a bottom, a sidewall extending upwardly from at least a portion of a periphery of the bottom, and a lip extending inwardly from at least a portion of the sidewall.

27. The kettle of claim 24, wherein the lid has a bowl-shape with an inwardly extending lip at an upper end of the lid.

28. The kettle of claim 24, wherein the lid is constructed and arranged to be received into the opening so that an upper end of the lid lies flush with the top portion.

29. The kettle of claim 28, wherein the lid comprises a gripping portion that is positioned below the upper end of the lid.

30. A kettle for heating a liquid, comprising:
a container arranged to hold an amount of liquid, the container having a substantially flat bottom portion and a top portion with an opening through which to receive the liquid;
a handle connected to the container and constructed and arranged to be gripped by a human hand and allow carrying of the container while holding the amount of liquid;
a spout connected to the container and constructed and arranged to allow liquid to be poured from the container; and
a lid constructed and arranged to cover the opening in the top portion of the container, the lid having an upper end and a bottom end, the bottom end being received into the container and the upper end being flush with the top portion of the container when the lid is in place to cover the opening, the lid comprising a gripping portion that is positioned below the upper end of the lid and is constructed and arranged to provide for removal of the lid from the opening by gripping the lid with fingers only and without use of a thumb.

31. The kettle of claim 30, wherein the lid has a bowl-shape with the gripping portion formed at a lip of the bowl-shape.

32. A kettle for heating a liquid, comprising:
a container arranged to hold an amount of liquid, the container having a substantially flat bottom portion and a top portion with an opening through which to receive the liquid;
a handle connected to the container and constructed and arranged to be gripped by a human hand and allow carrying of the container while holding the amount of liquid;
a spout connected to the container and constructed and arranged to allow liquid to be poured from the container; and
a lid constructed and arranged to cover the opening in the top portion of the container, the lid having a bowl shape arranged so that an inner sidewall forming the bowl shape provides a surface by which the lid may be pulled using one or more fingers to remove the lid from the opening.

33. The kettle of claim 32, wherein the lid has a bottom, a sidewall extending upwardly from a periphery of the bottom, and a flange extending inwardly from an upper end of the sidewall.
